(19) United States
(12) Patent Application Publication
(10) Pub. No.: US 2010/0206420 A1
(43) Pub. Date: Aug. 19, 2010

(54) FLOW METER FOR MULTIPHASE FLUIDS

(75) Inventor: Johnny Jakobsen, Bergen (NO)

Correspondence Address: NIXON & VANDERHYE, PC, 901 NORTH GLEBE ROAD, 11TH FLOOR, ARLINGTON, VA, 22203, US

(73) Assignee: Roxar Flow Measurement AS, Bergen (NO)

(21) Appl. No.: 12/738,733

(22) PCT Filed: Oct. 16, 2008
(86) PCT No.: PCT/NO08/00368

§ 371 Date: Apr. 19, 2010

(30) Foreign Application Priority Data
Oct. 17, 2007 (NO) 20075305

(51) Int. Cl. F16L 9/14; B23P 17/00

(52) U.S. Cl. 138/142; 29/890.14; 138/143

(57) ABSTRACT

There is described a flow pipe (10) of metal for use in a flow meter for fluids, particularly multiphase fluids. The flow pipe has a main run (7) and one or more laterally extending channels (t) of small diameter relative to the main run. The internal surface of the main run that defines the flow area, is cladded with a corrosion and wear resistant metallic material (6) different from the metallic material of the remainder of the flow pipe. The material that encloses and defines the laterally extending channels (t) is of the same metallic material as the internal surface of the flow pipe. Consequently a continuous and integrated internal cladding is formed in the main run so that a fluid in the flow pipe (10) is in contact with the corrosion and wear resistant material only.

The present invention relates to a flow pipe of metal for use in a flow meter for fluids, including multiphase fluids, which flow pipe has a main run having predetermined flow area over a certain distance, and one or more transversally or laterally extending channels of small diameter compared with the main run, the internal surface of the main run that defines the flow area is coated or cladded with a corrosion and wear resistant metallic material different from the metallic material in the remainder of the flow pipe.

The invention also relates to a method of preparing and machining of a metallic flow pipe for use in a flow meter of the introductory defined kind.

This type of flow meter is suited for use both as pure flow meter and to perform sampling of the production fluid in an oil and/or gas well. It is used to make tests of the well for continuous monitoring of the reservoir and development in every single well during the production life time thereof. A correct test will therefore determine the proper point in time to make changes in the well flow and also survey water or gas break through.

The vitality of many of the marginal fields in deep waters depends on multiphase transportation over long distances of the untreated well flow. A key factor in such projects is the availability of a meter that is able to meter the fractional shares and the quantities of oil, gas and water without need of separation into the individual fractions. Huge amounts of costs can be saved if marginal fields are developed as mini facilities or satellites, including multiphase transportation of the untreated well stream. The present flow meter provides the industries a unique instrument to support such development.

However, it is well known that such flow meters need to be robust, maintenance free and resistant to corrosion, in particular H₂S and CO₂. In order to obtain this the meters have so far been made of the material Inconel, which has the required strength and corrosion properties. Inconel is a material having high content of chrome-nickel. But this material is exceptionally expensive. For example the quality grade Inconel 625 can vary in price from NOK 350-500 per kg, depending on the size of the item. A normal Duplex steel material will be approximately NOK 45-50 per kg.

Thus the issue to be addressed has been how to obtain a solution that uses a large share of inexpensive Duplex material and a lesser share of corrosion resistant expensive Inconel material? The Duplex material alone will not be satisfactory in view of corrosion durability.

Expressed in a different way, the object has been to find a solution where only the internal parts that are in direct contact with the flowing fluid is of the more expensive corrosion resistant material. In practise this means the material which surrounds or defines the main flow path and the laterally extending branches for pressure tapping or pressure relief. It is to be understood that the main stream path and each laterally extending branch need to be integrated so that they form a continuity, omit splices/joints such that the fluid present within the flow pipe is in contact with this corrosion and wear resistant metallic material only.

Further, it has actually been a problem to be able to supply high-alloy materials, and in particular when the dimensions is about to be large. By the present solution the time for delivery will be possible to shorten.

According to the present invention a flow pipe of the introductory said kind is provided, which is distinguished in that the material that encloses and defines the transversally extending channels is of the same metallic material as the internal surface of the flow pipe, and that this metallic material is fused together with the metallic material of the internal surface of the flow pipe for the creation of a continuous and integrated internal cladding in the main run and the channels so that a fluid present in the flow pipe is in contact with this corrosion and wear resistant metallic material only.

In a convenient embodiment the internal surface of the flow pipe can be a surface machined clad weld welded to the metallic material in the remainder of the flow pipe, most often in several layers, like three layers.

In another embodiment the internal surface of the flow pipe can be in form of a sleeve like body installed into the main run of the flow pipe.

The corrosion and wear resistant material can be high-alloy metal such as Inconel, Hastalloy and 6Mo.

Preferably the remaining metallic material within the flow pipe can be a Duplex material or other low-alloy material, even carbon steel.

Each channel can be in the form of an opening which is lined with Inconel in sealed extension of the clad weld on the internal surface of the flow pipe.

As an alternative a channel can be in the form of an axial bore through a bolt of the material Inconel, in which the bolt in a sealed way welded to the clad weld of the internal surface of the flow pipe.

According to the present invention a method of the introductory said kind is provided, which is distinguished in that for each channel a bore through the body of the flow pipe is formed and further through the cladded corrosion and wear resistant layer, that a solid plug or bolt of same corrosion and wear resistant metallic material is provided in the bore, that the plug or bolt is welded internally in a fusing, sealing and integrating way to the corrosion and wear resistant cladding material of the flow pipe and that the plug or the bolt is axially drilled for creation of said channel such that the fluid that may exist in the flow pipe is in contact with this corrosion and wear resistant metallic material only.

Preferably the plug or bolt is additionally welded externally in a fused together way to the remaining body of the flow pipe before the plug or the bolt is axially drilled for creation of said integrated channel.

In a convenient embodiment the plug is built up by means of clad welding.

In another embodiment a hollow or solid bolt is used where the bolt is forced or threaded into place in the bore, said bore being a pilot bore adapted to the press fit of the bolt.

Preferably the plug or bolt is additionally grinded internally within the flow pipe so that the tip of the plug or bolt follows the internal surface curvature of the main run.

Typically the welding will take place in that relative movement is effected between a welding probe and the flow pipe where the starting point for the probe is at the minimum internal radius, when it comes to a Venturi pipe.

Estimated cost savings on purchase of ready manufactured flow meter in Inconel versus Duplex/Inconel will amount to approx. NOK 200.000 per flow meter designed for 4″ pipe. Further savings are achieved on heavier pipe dimensions.

Other and further objects, features and advantages will appear from the following description of preferred embodiments of the invention, which is given for the purpose of description, and given in context with the appended drawings where:

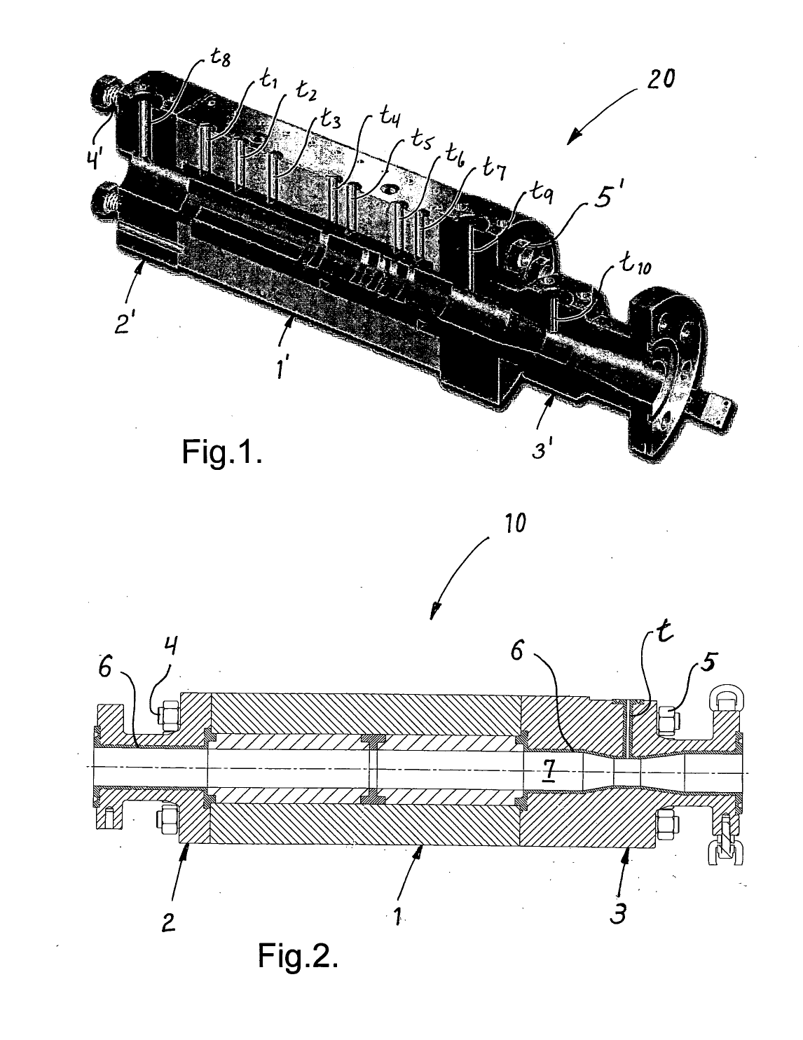

FIG. 1 shows an axial section in perspective view of a flow meter according to the prior art,

FIG. 2 shows an axial section through the same flow meter as the one depicted in FIG. 1, having the invention drawn into it, and

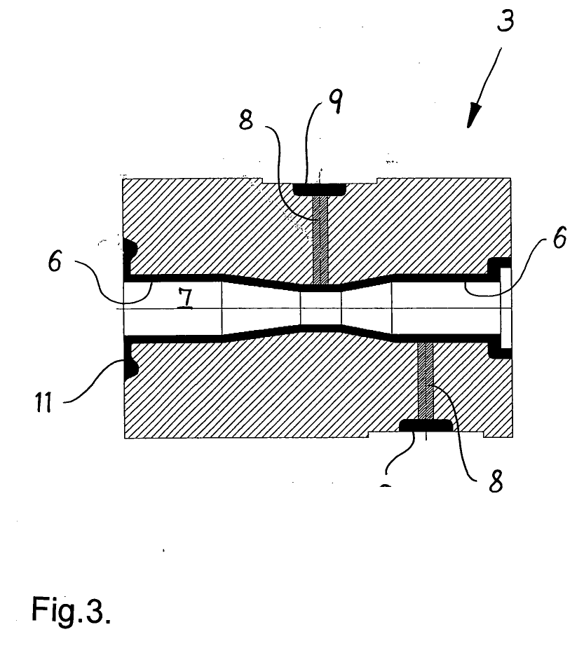

FIG. 3 shows an axial section through the body of the Venturi part of a flow pipe.

Reference is first made to FIG. 1 which in general illustrates a flow meter 20 according to common prior art. The flow meter 20 is assembled of a main body 1′, a flange part 2′ and a Venturi part 3′ which all together defines a main run 7. The main body 1′ has a number of pressure tapping openings t₁-t₇ in the form of channels to perform sampling in a multiphase production flow. These channels have substantially less diameter than the main run.

The flange part 2′ has a pressure tapping opening t₈ in order to be able to provide a first pressure reference.

The Venturi part 3′ has two pressure tapping openings t₉ and t₁₀ in order to be able to provide a second and third reference pressure. The pressure tapping t₁₀ is located in the minimum flow area of the Venturi.

The three main parts are kept together by means of long bolts 4′ and nuts 5′.

Reference is now made to FIG. 2 which basically shows the same as FIG. 1, e.g. a flow meter 10 which is assembled of a main part 1, a flange part 2 and a Venturi part 3 and are kept together by bolts 4 and nuts 5. However, the flow meter 10 is now internally coated or cladded with an Inconel material and is shown in the figure as the hatched area marked 6. Other corrosion and wear resistant material that are contemplated are high-alloy metals such as nickel alloys, Hastalloy and 6Mo. In the Venturi part 3 a channel or pressure tapping t is also illustrated.

Normally this material will be applied by clad welding. Clad welding is normally TIG welding and takes place by means of a robot. This is performed in that the parts are welded in a carousel. A welding arm enters the opening and welds two to three layers of Inconel. Thereafter the parts are surface machined by turning. It is a usual understanding that the welded part should not be turned down into the first layer because this layer may have too high content of ferrite.

The opening of the flow pipe is to be dimensional checked before welding. This needs to be done in order to be able to secure control of the Inconel thickness subsequent final turning.

However, it is to be understood that the internal surface of the flow pipe in stead of being a clad weld, could be in the form of a sleeve like body which is installed into the remaining Duplex material. The sleeve like body is like the clad weld of a high-alloy metal such as Inconel, Hastalloy and 6Mo.

The sleeve like body is welded tight in top and bottom. When it comes to the channels/pressure tappings t, it will be necessary to drill a larger hole for subsequent filling of the hole with welding material and then drill a hole in centre.

FIG. 3 shows the Venturi pipe 3 itself, where the main run 7 is internally cladded by means of a clad welding 6 in several layers as described below. In addition the installation of bolts 8 of a nickel alloy which are pressed into pilot bored and tapped holes is illustrated. Further, it is also shown how each bolt 8 is welded 9 external around the head (not shown) and to the remainder of the body of the Venturi pipe 3. Each bolt 8 is also welded internally at the end towards the main run 7. Correspondingly, extended welding zones 11 at each end of the main run 7 are provided.

When it comes to the method for preparing and machining, this will take place as follows. The flow pipe is basically of Duplex material or similar. The pipe stock is initially rough turned internally to form the main run 7 with the Venturi 3 before holes are drilled for each lateral branch to receive the bolts 8 of Inconel or similar.

The 1^{st} step of the adaptation is that the bolt 8 of Inconel, or similar material, is adapted in the longitudinal direction thereof. The bolt is to be flush with internal and external machined surfaces. Internally the bolt 8 is grinded such that the tip follows the contour of the internal surface of the main run 7.

The 2^{nd} step is that the bolt 8 is spot welded externally so that the bolt shall not be displaced during subsequent welding by robot.

The 3^{rd} step takes place in that a first layer of weld starts internally at the start of the cone ledge towards the minimum diameter of the Venturi part 3. A welding table revolves while the welding probe is moved outwards at the same time as it follows the internal contour of the Venturi. A second weld layer starts 5-10 mm further inwards in the longitudinal direction of the first weld layer. This is to obtain a defined plane for the second layer, the welding probe follows the contour of the Venturi. A third weld layer starts 5-10 mm further inwards in the longitudinal direction of the second weld layer. This is to obtain a defined plane for the third layer. The welding probe follows the contour of the Venturi. The thickness of the layers will be in the order of magnitude 3 mm.

In the 4^{th} step the Venturi is turned around, and the root or the start of the preceding three weld layers are grinded clean from welding slag. The weld starts at the root of the preceding weld and follows the contour of the Venturi. The first welding layer now fuses together the Inconel bolt 8 and the internal weld. The welding probe then follows the same principle as in the 3^{rd} step until all three layers are welded.

The 5^{th} step is external welding of counter milled surface around the Inconel bolt. The welding probe starts in the outer periphery and works in circles inwardly towards the centre of the Inconel bolt. Layer on layer-of weld are cladded until sufficient welding stratum is achieved.

The 6^{th} step includes finishing with final milling and turning according to dimensions on drawings.

Material of Inconel is a specified group of materials. “Nickel alloys” covers several groups of material.

As said, an alternative is also that the bolt of Inconel is replaced by a plug made up by weld layers.

1. A flow pipe (10) of metal for use in a flow meter for fluids, including multiphase fluids, which flow pipe has a main run (7) having predetermined flow area over a certain distance, and one or more lateral extending channels (t) of small diameter relative to the main run, the internal surface of the main run that defines the flow area, is cladded with a corrosion and wear resistant metallic material (6) different from the metallic material of the remainder of the flow pipe, characterized in that the material that encloses and defines the laterally extending channels (t) is of the same metallic material as the internal surface of the flow pipe, and that this metallic material is fused together with the metallic material of the internal surface of the flow pipe to form a continuous and integrated internal cladding in the main run (7) and the channels (t) so that a fluid present in the flow pipe (10) is in contact with this corrosion and wear resistant metallic material only.

2. The flow pipe according to claim 1, characterized in that the internal surface of the flow pipe is a surface machined clad weld welded to the metallic material in the remainder of the flow pipe, most often in several layers, like three layers.

3. The flow pipe according to claim 1, characterized in that the internal surface of the flow pipe is in form of a sleeve like body installed into the main run of the flow pipe.

4. The flow pipe according to claim 1, characterized in that the corrosion and wear resistant material is a high-alloy metal such as Inconel, Hastalloy and 6Mo.

5. The flow pipe according to claim 1, characterized in that the remaining metallic material of the flow pipe is a Duplex material or other low-alloy material, even carbon steel.

6. The flow pipe according to claim 1, characterized in that each channel is in the form of an opening which is lined with Inconel in sealed extension of the clad weld on the internal surface of the flow pipe.

7. The flow pipe according to claim 6, characterized in that each channel is in the form of an axial bore through a bolt of the material Inconel, in which the bolt in a sealed way is welded to the clad weld on the internal surface of the flow pipe.

8. A method of preparing and machining of a metallic flow pipe for use in a flow meter for a fluid flowing through the flow pipe, which flow pipe has a main run and one or more transversally extending channels of small diameter compared with the main run, and the internal surface of the flow pipe, which defines the main run and the flow area, is cladded with a corrosion and wear resistant metallic material different from the metallic material of the remainder of the flow pipe, characterized in that for each channel is a bore formed through the body of the flow pipe and further through the cladded corrosion and wear resistant layer, that a solid plug or bolt of same corrosion and wear resistant metallic material is provided in the bore, that the plug or bolt is welded internally in a fusing, sealing and integrating way to the corrosion and wear resistant cladding material of the flow pipe and that the plug or the bolt is axially drilled for creation of said channel such that the fluid that may exist in the flow pipe is in contact with this corrosion and wear resistant metallic material only.

9. The method according to claim 8, characterized in that the plug or bolt is additionally welded externally in a fused together way to the remaining body of the flow pipe before the plug or the bolt is axially drilled for creation of said integrated channel.

10. The method according to claim 8, characterized in that the plug is built up by means of clad welding.

11. The method according to claim 8, characterized in that the bolt is forced into place in the bore, said bore being a pilot bore adapted to the press fit of the bolt.

12. The method according to claim 8, characterized in that the bolt is threaded into place in the bore, said bore being a threaded opening for cooperation with a threaded bolt.

13. The method according to claim 8, characterized in that the plug or bolt is additionally grinded internally within the flow pipe so that the plug or bolt follows the internal surface curvature of the main run.

14. The method according to claim 8, characterized in that the welding takes place in that relative movement is effected between a welding probe and the flow pipe where the starting point for the probe is at the minimum internal radius.
